(19) United States
(12) Patent Application Publication
(10) Pub. No.: US 2008/0296157 A1
(43) Pub. Date: Dec. 4, 2008

(54) Method and Device for Handling Sedimenting Particles

(75) Inventors: Gunter Bauer, Schmalfeld (DE); Torsten Muller, Berlin (DE); Thomas Schnelle, Berlin (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: PerkinElmer Cellular Technologies Germany GmbH, Hamburg (DE)

(21) Appl. No.: 12/088,009

(22) PCT Filed: Sep. 27, 2006
(86) PCT No.: PCT/EP2006/009396

§ 371 Date: Jul. 29, 2008

(30) Foreign Application Priority Data
Sep. 30, 2005 (DE) 10 2005 047 131.5

(51) Int. Cl. B01D 35/06; B03C 5/02; B03C 1/30; B03C 1/02

(52) U.S. Cl. 204/557; 210/222; 210/223; 210/243; 204/571; 210/695

(57) ABSTRACT

The invention relates to a method for handling particles (1, 2) that are suspended in a carrier liquid (3). The method includes the following steps: the carrier liquid (3) is received with the particles (1, 2) in a liquid siphoning device (10) including at least one siphoning opening (11), electrical and/or magnetic separating fields are generated in the liquid siphoning device (10), a sedimentation movement of the particles (1, 2) is created in the liquid, each particle having a sedimentation speed that depends on the action of the separating fields on the particle (1, 2) and the particles (1, 2) forming a plurality of particle fractions (5, 6) according to the sedimentation speeds thereof, and the particle fractions (5, 6) are separately extracted from the liquid siphoning device (10). The invention also relates to a handling device (100) for handling suspended particles (1, 2).

The invention relates to a method for manipulating suspended particles under the effect of electric and/or magnetic separating fields, in particular to a method for manipulating biological particles under the effect of dielectrophoretic and/or magnetic separating forces. The invention also relates to a device for manipulating suspended particles by means of electric and/or magnetic separating fields. The device is in particular a manipulation device for biological particles, which are separated into different particle fractions by dielectrophoretic and/or magnetic separating forces as a function of predefined particle properties.

It is known to manipulate suspended particles under the effect of negative dielectrophoretic field forces. By way of example, T. Müller et al. in “Biosensors and Bioelectronics”, Vol. 14, 1999, pages 247-256 describe holding individual biological cells in field cages under the effect of negative dielectrophoresis and analyzing said cells or sorting them using field barriers. The field cages or field barriers are formed by high-frequency electric fields which are generated by electrodes in compartments of the microsystem. The movement of the cells towards a field cage or towards a field barrier takes place by means of hydrodynamic forces. The cells are moved through the compartments by a flow of the carrier liquid in which the cells are suspended. In order to generate the hydrodynamic forces, the conventional microsystem is connected to a fluidic device which can be used to maintain a continuous flow of the carrier liquid. The coupling of the microsystem to the fluidic device, which comprises e.g. an injection pump, may restrict the mobility of the microsystem. The freedom of movement of the microsystem is restricted by the connection of liquid lines, which may be particularly disadvantageous for laboratory uses in cell biology. Another disadvantage of the conventional particle movement by means of hydrodynamic forces is that low speeds (less than 50 μm/s) can be set only imprecisely and with little reproducibility using conventional fluidic devices. It is known from EP 1 089 823 to transport particles by means of a sedimentation movement in the fluidic microsystem. Sedimentation forces, which are generated by gravitation or centrifugation, allow a precise and reproducible setting of low particle speeds. In this case too, however, the microsystem for holding a particle suspension must be connected to a fluidic device, and therefore the problem of the restricted freedom of movement and complicated handling of the microsystem arises again.

In the conventional techniques, the microsystem is formed by a fluidic chip. One disadvantage when using the fluidic chip may lie in its limited compatibility with the rest of the technology used in a laboratory e.g. for chemical, biological and in particular cell-biological analyses. The fluidic chips require a complex fluidic periphery, which may represent an unacceptably high effort when only a few cells are to be manipulated and in particular sorted. While the provision of the fluidic periphery lends itself to high-throughput applications, laboratory devices for flexible use even in the case of small sample quantities and under varying use conditions are not yet available.

The object of the invention is to provide an improved method for manipulating suspended particles, by means of which the disadvantages of the conventional technique are overcome and which has an extended range of application. The method according to the invention should in particular exhibit improved compatibility with available laboratory devices and should allow flexible use under various use conditions even in the case of small sample quantities. The object of the invention is also to provide an improved manipulation device for manipulating suspended particles, by means of which the disadvantages of the conventional fluidic microsystems are avoided and which in particular has a greater scope for use and an increased freedom of movement and easier handling compared to conventional fluidic chips.

These objects are achieved by a method or a manipulation device having the features of the independent claims. Advantageous embodiments and uses of the invention are defined in the dependent claims.

With regard to the method, the invention is based on the general technical teaching of influencing a sedimentation movement of suspended particles in a liquid siphoning device by means of electric and/or magnetic separating fields in such a way that a characteristic sedimentation speed (in particular sedimentation speed magnitude and/or sedimentation direction) is imposed on the particles as a function of the specific interaction with the separating fields. Depending on the sedimentation speeds of the particles, a plurality of particle fractions are formed which are preferably discharged separately from the liquid siphoning device. Unlike the conventional microsystem technique, the manipulation of the suspended particles does not take place in a fluidic chip but rather in a liquid siphoning device which preferably has at least one siphon opening.

The term “liquid siphoning device” (or “siphon”) here is used in general to mean a device for taking up and/or discharging liquids into or from open liquid reservoirs. The liquid siphoning device allows the take-up, temporary storage and subsequent discharging of a carrier liquid containing suspended particles, and can thus perform the transport function of the fluidic devices used in the conventional techniques. One significant advantage of the invention is that the generation of the electric and/or magnetic separating fields in the liquid siphoning device additionally allows a manipulation or in particular sorting of the particles. The conventional manipulation of suspended particles in the fluidic chip in combination with the fluidic device can be replaced according to the invention by the manipulation of the suspended particles in the liquid siphoning device.

Advantageously, the liquid siphoning device can be used for liquid transport in an independent and flexible manner without additional fluidic devices. The liquid siphoning device can in particular be moved freely or brought into a rest position manually or by means of a mechanical actuator after the take-up of the suspended particles, while the manipulation of the particles takes place. Another important advantage of the invention is that very small quantities of cells, e.g. two cells, can be separated from one another by means of the e.g. dielectrophoretic separation.

An interaction of the particles with the electric and/or magnetic separating fields is used to manipulate the particles. In different embodiments of the invention, the influencing of the sedimentation speed of the particles as a function of their interaction with the separating fields may result in a change in magnitude and/or direction of the sedimentation speed.

In order to change the magnitude of the sedimentation speed, separating forces are generated which, depending on the particle properties, result in an increased sedimentation speed for some particles and in a reduced sedimentation speed for other particles, so that the particles can accumulate into the separate particle fractions. The sedimentation speed can if necessary be reduced to zero.

Due to a change in direction of the sedimentation speed, particles with different properties accumulate on different sedimentation paths in the liquid siphoning device, so as to allow separate discharging of the particle fractions.

One particular advantage of the invention lies in the variety of interactions between the particles and the separating fields, on the basis of which the separating forces can be generated. By way of example, dielectrophoretic, electrophoretic, magnetic and/or electromagnetic separating forces may be generated, which accordingly have different effects on particles with different properties which include dielectric properties, magnetic properties, polarization properties and/or conductivity properties of the particles. For example, by suitably selecting the frequency of the electric separating field, it is possible for different dielectrophoretic forces to be exerted on biological cells which differ from one another in respect of at least one of the properties consisting of composition, size and shape. When particles with different properties are accordingly subjected to negative dielectrophoresis separating forces of different strength, they can sediment at different speeds in the liquid siphoning device. Alternatively, undesired particles can be fixed by means of positive dielectrophoresis or by means of electrophoresis at electrodes for generating the electric separating fields, and thus form a separate particle fraction.

When dielectrophoretic separating forces are exerted on the suspended particles, particular advantages are achieved with regard to the precision and selectivity of the separation. According to a first variant, the separation takes place by setting the separating fields in such a way that negative dielectrophoretic separating forces of different strength act on different particles. Differences in the negative dielectrophoretic separating forces may lead for example to the situation where different particles sediment at different speeds or where different particles are moved on different sedimentation paths depending on the interaction of the separating forces with the sedimentation forces. The exertion of negative dielectrophoretic separating forces of different strength has the advantage that a field effect is exerted on all the particles contained in the suspension and the particles are manipulated in a contactless manner in the liquid siphoning device. According to a second variant, it is provided that positive dielectrophoretic separating forces are exerted on some of the particles. In this case, the particles in question are attracted towards an electrode for generating the separating fields. This variant has the advantage that the separation sharpness of the particle manipulation is improved by the at least temporary fixing of the particles at the electrode. Finally, according to a third variant, it is possible for the separating fields to have no effect on some of the particles, so that these unaffected particles perform exclusively the sedimentation movement. In this case, advantages are obtained with regard to the simplified setting of the separating fields.

Particularly when positive dielectrophoretic separating forces are exerted which hold back some of the particles in the liquid siphoning device, it is possible to omit the take-up of buffer liquid. In this case, the separating fields can be generated in the siphon channel directly after the siphon opening.

The liquid siphoning device generally has a reservoir for receiving the carrier liquid containing the suspended particles, which reservoir comprises at least one siphon channel with a predefined length. In the operating position, the liquid siphoning device is oriented in such a way that the length direction deviates from the horizontal and preferably runs vertically. Each siphon channel has at its free end a siphon opening, through which the carrier liquid can be taken up into the liquid siphoning device from a reservoir having a free liquid surface. In the operating position, the siphon opening is arranged at a lower end of the liquid siphoning device. The reservoir comprises a vessel, such as e.g. a compartment of a microtiter plate, or a free substrate surface, such as e.g. a microscope slide.

Using the method according to the invention, a particle separation can take place in particular based on the following considerations. For the simplified case of particle separation without a change in sedimentation direction, the sedimentation speed is determined in a known manner from the following force equation:

F_{hyd}=F_{g}+F_{z} (1)

wherein the gravitational force and hydrodynamic force for a spherical particle with radius r is given as

F_{g}=4/3π³g(ρ_{particle}−ρ_{medium})=4/3π³gδρ and F_{hyd}=6πηrv (2)

Here, g, ρ, δρ, η and ν represent gravity, density, difference in density, viscosity of the medium and particle speed. In order to vary the sedimentation speed, either an additional force can be exerted on the individual particles in the sedimentation direction or the hydrodynamic resistance can be changed. The flow resistance can be changed by a change in orientation and/or a deformation and/or an aggregation of the particles (larger objects of equal density and symmetry sediment more quickly). This can be achieved for example in homogeneous electric or magnetic external fields. F_{z} may be homogeneous fields (e.g. electrophoresis) or gradient fields (e.g. dielectrophoresis or magnetophoresis) which, like the sedimentation force, scale with r³. It may also be provided that the particles are set in rotation (e.g. electrorotation in rotating electric fields) in order thus to change their movement path (Magnus effect).

If, according to a preferred embodiment of the invention, the suspended particles are taken up with a carrier liquid through the at least one siphon opening into the liquid siphoning device, particular advantages are achieved with regard to the multiple function of the liquid siphoning device according to the invention for transporting the carrier liquid and manipulating the suspended particles.

Particular preference is given to an embodiment of the invention in which the liquid siphoning device has only one siphon opening, which is used as a fluidic inlet and outlet.

The take-up of the carrier liquid containing the suspended particles may be achieved by the exertion of a negative pressure in the liquid siphoning device. Unlike conventional fluidic devices, it is advantageously sufficient if a relatively low negative pressure is exerted and then maintained for a predefined suction time. To this end, a rubber balloon or a pressure piston may be used for example as in the case of conventional liquid siphoning devices.

If, according to a further preferred embodiment of the manipulation method according to the invention, firstly the carrier liquid containing the suspended particles and then a buffer liquid without particles is taken up into the liquid siphoning device, advantages may be achieved with regard to a reliable displacement of the carrier liquid containing the suspended particles to a predefined start position relative to a manipulation region, in which the separating fields are exerted. The take-up of the buffer liquid has the further advantage that the carrier liquid containing the suspended particles is separated from the siphon opening in the liquid siphoning device. It is thus possible to prevent undesirable environmental influences on the particles, in particular on biological cells or other biological particles, during the sedimentation. The buffer liquid may be identical to the carrier liquid, but without the particles. Alternatively, another liquid may be used as the buffer liquid. In biological applications of the invention, the buffer liquid comprises e.g. an isotonic aqueous solution.

As a result of creating a sedimentation speed dependent on the respective separating force, the particles, if only one type of particle is contained in the sample, accumulate into one particle fraction, and preferably for particle sorting into at least two particle fractions. Advantageously, the method according to the invention has a high degree of flexibility with regard to the separate discharging of the particle fractions from the liquid siphoning device. According to a first alternative, the particle fractions can be discharged in a temporally separate manner. After sedimentation and accumulation into the particle fractions, the particles with the highest sedimentation speed can exit first from the liquid siphoning device, followed by the particles with lower sedimentation speeds. Advantageously, the liquid siphoning device can be moved between different target reservoirs between the phases of discharging a specific particle fraction, so that the different particles can be deposited in different compartments or on different substrates for further processing, analysis or the like. According to a second alternative, the particle fractions can be discharged from the liquid siphoning device in a spatially separate manner. To this end, during the sedimentation movement under the effect of the separating fields, different particles are deflected into different siphon channels. This embodiment of the invention is advantageous since the particle fractions can be deposited in or on different target reservoirs in parallel. The two variants of temporally and spatially separate discharging of the particle fractions can be combined.

According to a particularly preferred embodiment of the invention, the particle fractions are discharged through the at least one siphon opening of the liquid siphoning device. The siphon opening is advantageously used both for taking up and for discharging the carrier liquid, wherein for discharging purposes the initially prevailing negative pressure can be replaced by a constant positive pressure in order to accelerate the discharging of the carrier liquid containing the separated particle fractions. The positive pressure may be exerted e.g. by means of an integrated injection pump or by the exertion of a mechanical prestress, e.g. by means of a spring on the pressure piston. However, it is not absolutely necessary for the siphon opening to serve as inlet and outlet. As an alternative, the filling of the liquid siphoning device may take place through a further opening which is arranged for example at the opposite end of the liquid siphoning device relative to the siphon opening.

For the manipulation of suspended particles according to the invention, firstly a predetermined volume of the carrier liquid (e.g. suspension of a cell sample) is taken up by the liquid siphoning device. Subsequently, particle-free buffer liquid (separation medium) can then be taken up. At the same time as the take-up of the buffer liquid, the carrier liquid containing the suspended particles is transported into the start position for sedimentation in the manipulation region or upstream of the manipulation region in which the electric and/or magnetic separating fields are generated. The liquid siphoning device is then placed in a holding device. During the subsequent sedimentation movement, the separating fields are generated so that the particles are selectively influenced with regard to their sedimentation speed (magnitude and/or direction).

If, according to a further embodiment of the invention, the magnetic separating fields form at least one magnetic field gradient in the liquid siphoning device, advantages are obtained with regard to the reliable separation of particles which are subjected to force in the magnetic field (magnetic particles) and other particles on which the magnetic field has no effect (non-magnetic particles). In the magnetic field gradient, it is advantageously possible to separate particles which consist of magnetic beads, or which are connected to magnetic beads, from non-magnetically labeled particles.

According to a further embodiment of the invention, it may be advantageous to combine electric and magnetic separating fields in the liquid siphoning device. The simultaneous generation of electric and magnetic separating fields allows the simultaneous separation of the particles as a function of different particle properties (e.g. dielectric and magnetic properties). Alternatively, the electric and magnetic separating fields may be generated at different times or in different sub-manipulation regions in the liquid siphoning device during the sedimentation movement. By way of example, after the start of sedimentation, firstly the generation of magnetic separating fields and then the generation of dielectrophoretic separating fields may be provided, so as first to separate magnetically labeled particles from non-magnetically labeled particles and then to carry out a separation as a function of the dielectric properties. As an alternative, firstly the electric separating fields and then the magnetic separating fields can be generated.

According to a further embodiment of the invention, it may be provided that the separating fields form at least one separating field and/or one separating field gradient in which the particles carry out an orientation movement as a function of a predefined particle property (e.g. polarizability, magnetic dipole). Advantageously, the sedimentation speed and thus the separation of the particles into the particle fractions can be influenced by the orientation movement. With particular preference, the setting of an orientation of the particles is dependent on the particle shape, the particle geometry, the particle structure and/or the particle composition.

Another significant advantage of the invention consists in the variety of available sedimentation forces which can be used to induce the sedimentation movement. The sedimentation forces give rise to a constant force effect which is exerted in the same way on all particles. According to preferred variants, the sedimentation forces comprise the gravitational force and/or centrifugal force, since conventional sedimentation techniques in a vessel at rest or in a centrifuge are available for these. Furthermore, it is also possible to use a magnetic sedimentation force, a dielectrophoretic sedimentation force, an electrophoretic sedimentation force, an electromagnetic sedimentation force or a combination of these forces to assist the sedimentation movement.

If, according to a further modification of the invention, the carrier liquid containing the suspended particles is acted upon by ultrasound in the liquid siphoning device, undesirable particle aggregations can advantageously be broken up. This embodiment makes it possible to avoid clogging of the siphon channel. Moreover, ultrasound can also be used to change the movement path of the particles.

According to a further variant of the invention, after take-up of the carrier liquid, the liquid siphoning device is transferred into a holding device. If the sedimentation is essentially induced by the gravitational force, the liquid siphoning device is positioned in the holding device in such a way that the length of the at least one siphon channel runs vertically. The positioning of the liquid siphoning device may comprise insertion or suspension in a suitable frame. Advantageously, the operation of the liquid siphoning device can be simplified if, at the same time as the positioning of the liquid siphoning device in the holding device, the separating device is electrically connected to a power supply device.

The holding device may be designed to exert further sedimentation forces, and may comprise for example a centrifuge and/or a sedimentation magnet that can be switched on and off.

Another significant advantage of the invention is that the particles, apart from the positive dielectrophoretic fixing, are manipulated in a contactless manner in the liquid siphoning device. Preferred applications of the invention are therefore in biology and biochemistry. The suspended particles preferably comprise biological cells, cell components, cell groups, cell organelles, viruses, biological macromolecules or combinations thereof. However, the invention can be used not only for biological applications, but also with non-biological particles which are made for example from plastic, glass, minerals or ceramics. Furthermore, the suspended particles in a sample may comprise particles of biological origin and non-biological particles, which are separated from one another for example by the manipulation according to the invention. The particles preferably have a characteristic size in the range from 500 μm to 50 nm. The carrier liquid can be selected depending on the use of the invention, and may comprise a single-phase or multiphase liquid.

Another preferred application of the invention is the separation of particles in order to purify cell suspensions, e.g. for the patch clamp technique. By way of example, the method according to the invention can be used to separate living biological cells from dead or damaged cells or from cell fragments. As a result, a blocking of the suction points of a patch device by undesirable sample components is avoided, or target cells or aggregates are separated from larger or smaller objects. This works better using the technique according to the invention than in horizontal throughflow systems in which the larger objects easily sediment in calm-flow zones and may lead to clogging there.

According to a further variant of the invention, an electric field treatment of the suspended particles in the liquid siphoning device is provided, which also comprises a modifying of the particles as an alternative to or in parallel with the separation into different particle fractions. Advantageously, a cell poration or a cell fusion can be carried out in the liquid siphoning device. The invention makes it possible to carry out an electrotransfection (e.g. of siRNA) using simple means compatible with laboratory technology.

According to a further, independent aspect of the invention, only the electric field treatment of the suspended particles is provided in the liquid siphoning device, without sedimentation and without separation. In this case, the liquid siphoning device described here is equipped with a poration and/or fusion electrode arrangement, as known for example from the microsystem technique and constructed in such a way as described here with reference to the separating device.

In an embodiment of the invention which is preferred for the parallel treatment of relatively large suspension samples, the take-up of the carrier liquid into the liquid siphoning device comprises a simultaneous suction into a plurality of siphon channels. This variant allows the parallel take-up of samples e.g. from the compartments of a microtiter plate.

With particular preference, a pipetting device or a part thereof is used as the liquid siphoning device. The treatment of the suspended particles with electric and/or magnetic fields may be provided for example in at least one pipette tip or at least one pipette reservoir of a single or multiple channel pipette.

According to a further embodiment of the invention, it may be provided that the separation and/or efficiency of separation are monitored by optical and/or electrical measurement methods. For optical monitoring, the liquid siphoning device is equipped e.g. with a camera device. The electrical monitoring may be based on an impedance measurement in the liquid siphoning device.

With regard to the device, the abovementioned object is achieved in that a liquid siphoning device for taking up a suspension sample is provided with a separating device (e.g. electrode device or magnetic field device) for generating electric and/or magnetic separating fields in the liquid siphoning device. Advantageously, therefore, a multifunctional manipulation device is provided which is compatible with the laboratory technique used in practice.

The liquid siphoning device has one or more siphon channels. The siphon channels preferably run in a straight line with a predefined length. Typically, the plurality of siphon channels are arranged parallel to one another in one plane (one-dimensional siphon) or as a matrix (two-dimensional siphon).

According to one preferred embodiment of the invention, the separating device is arranged in at least one of the siphon channels. This variant is preferred due to the direct field effect of the separating device. This makes it easier to couple the electric and/or magnetic separating fields into the carrier liquid. As an alternative, the separating device may be arranged on an outer side of the liquid siphoning device in the vicinity of at least one of the siphon channels. In this case, possible undesirable effects of a substance (e.g. the carrier liquid) in the liquid siphoning device on the separating device are advantageously avoided. Furthermore, the structure and manufacture of the liquid siphoning device is simplified. The separating device may for example be releasably fixed to the outer side of the liquid siphoning device. This advantageously makes it possible to equip conventional liquid siphoning devices, such as e.g. pipettes or pipette tips, with a separating device in order to create the manipulation device according to the invention.

In order to generate electric separating fields, the separating device preferably comprises an electrode device with at least two strip-shaped or annular electrodes. Advantageously, the electrode device may be configured in the manner known from the conventional technique of fluidic microsystems. In order to generate magnetic separating fields, the separating device preferably comprises a magnetic field device. If the magnetic field device has at least one coil, the magnetic separating effect can advantageously be adjusted depending on the specific use of the invention. If the magnetic field device has at least one permanent magnet, advantages are obtained with regard to a simplified design of the manipulation device.

Advantages with regard to a particularly effective field effect can be achieved if the electrodes of the separating device have electrode gaps that are as small as possible. According to an advantageous embodiment of the invention, therefore, the at least one siphon channel of the liquid siphoning device has at least one sub-channel, the characteristic cross-sectional dimension of which is smaller than the cross-sectional dimension of the siphon channel and in which the electrodes of the separating device are arranged.

According to the invention, there is a wide range of available materials for producing the liquid siphoning device or at least the wall of the siphon channels. In particular, it is possible to use glass, plastic, ceramic, silicon, plastic nanoparticle composites or combinations of these materials. With regard to the effect of electric separating fields, it may be advantageous if the material from which the liquid siphoning device or at least the walls of the siphon channels are made differs dielectrically from the carrier liquid, e.g. from a saline solution. In this case, any possible influence e.g. of a wall material of the liquid siphoning device on the separating fields is reduced or prevented.

According to a particularly preferred use of the invention, the liquid siphoning device comprises a pipetting device or a part thereof. The pipetting device (e.g. a laboratory siphoning pipette), which can be designed essentially in the same way as conventional laboratory devices, is equipped with the separating device for generating the separating fields in the pipette reservoir and/or in the pipette tip. With regard to a high flexibility of use of the invention, it is particularly advantageous if the manipulation device comprises a pipette tip which is connected to the separating device. In this case, a conventional pipetting device can be equipped with the functionalized pipette tip according to the invention.

The use of a pipette tip, which is equipped with a separating device for generating electric and/or magnetic separating fields, for manipulating suspended particles forms an independent subject matter of the invention.

Further details and advantages of the invention will become apparent from the description of the appended drawings. In the drawings:

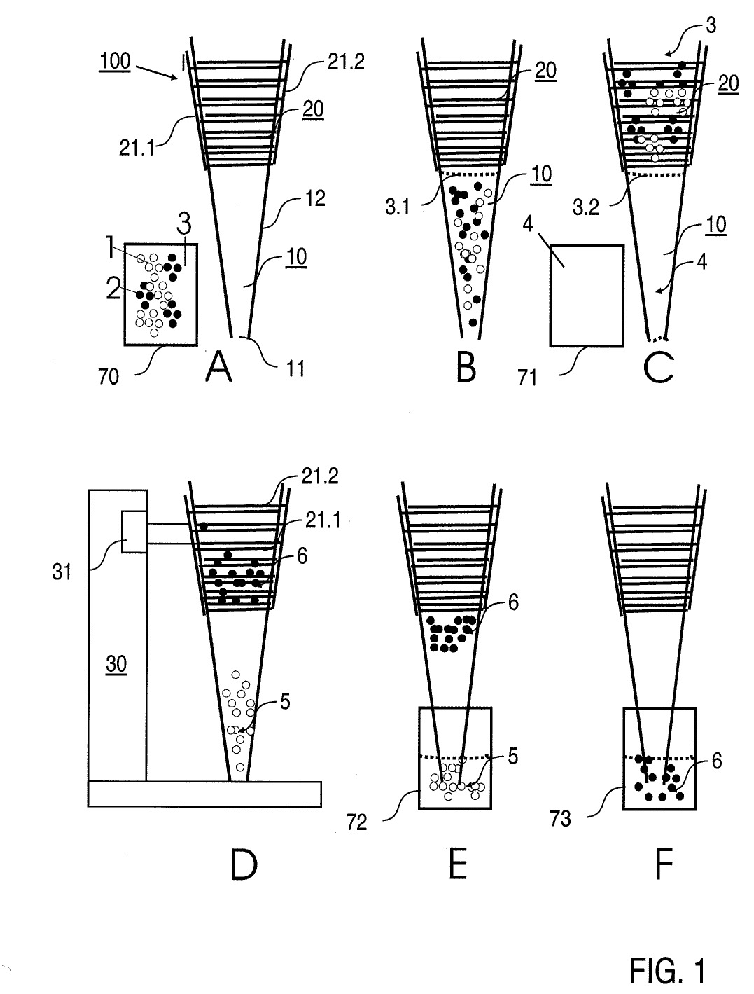

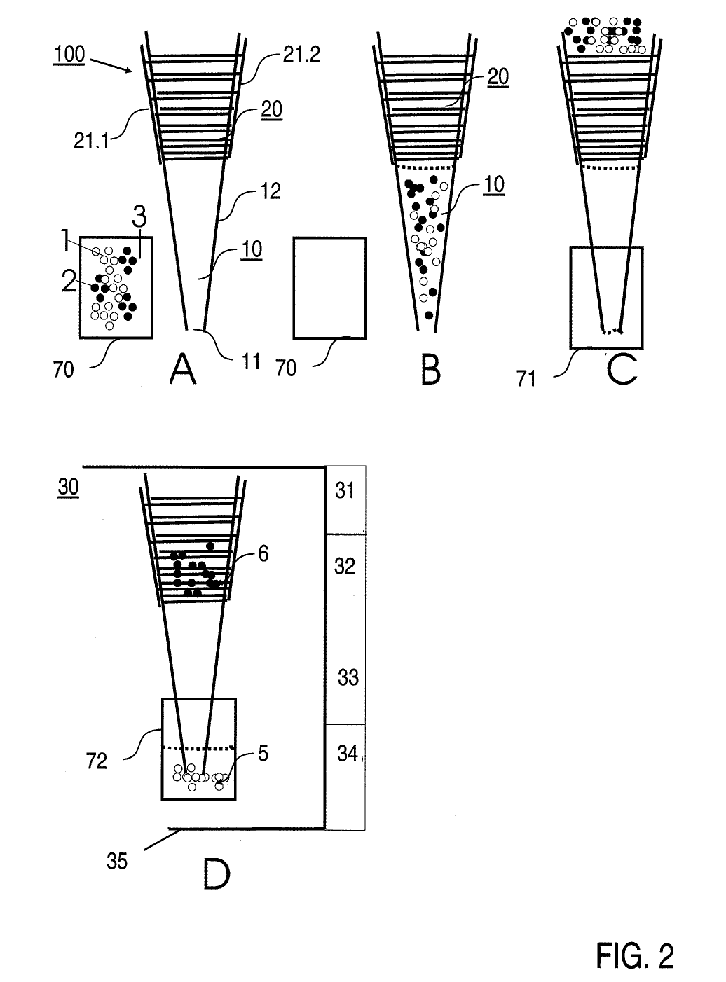

FIGS. 1 and 2: show embodiments of the method according to the invention for manipulating suspended particles,

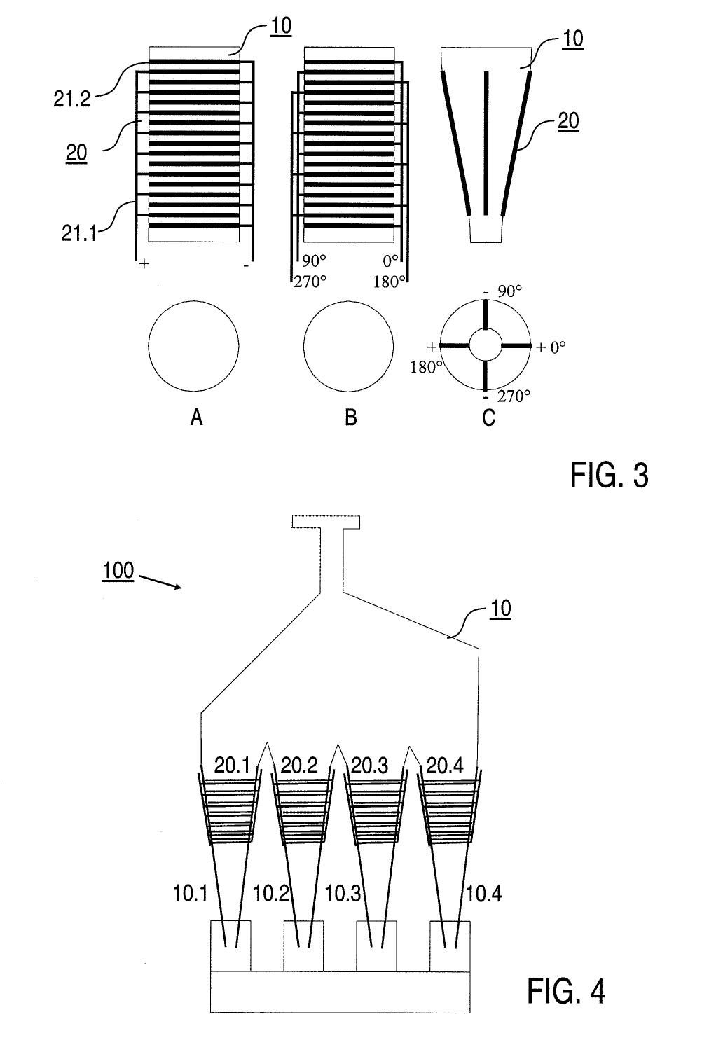

FIG. 3: shows embodiments of electrode devices according to different embodiments of the manipulation device according to the invention,

FIG. 4: shows a further embodiment of the manipulation device according to the invention with a plurality of siphon channels,

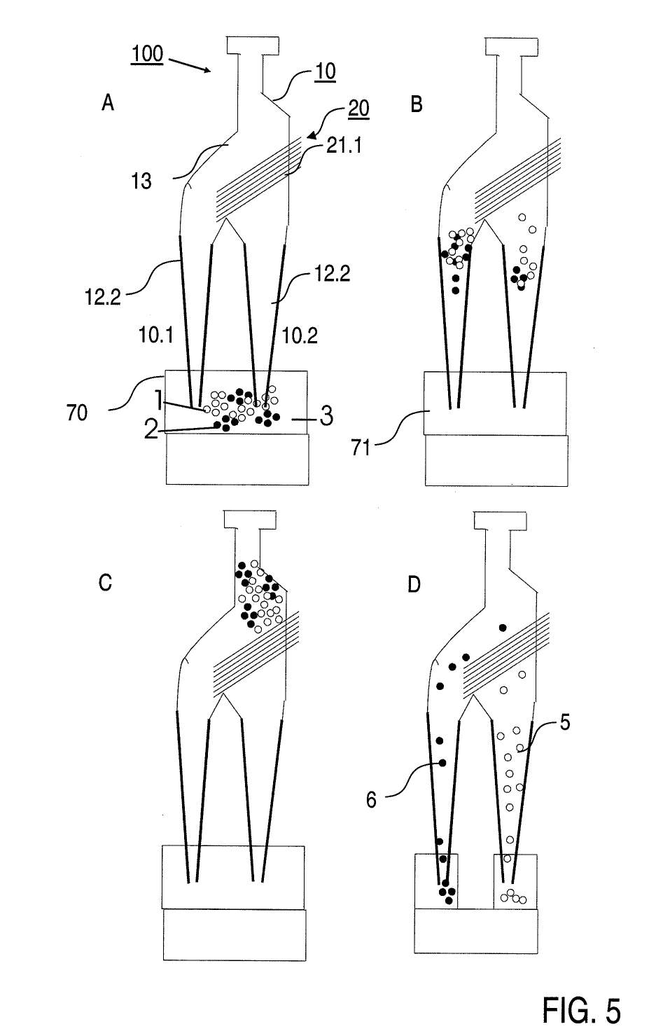

FIG. 5: shows a further embodiment of the manipulation of suspended particles according to the invention,

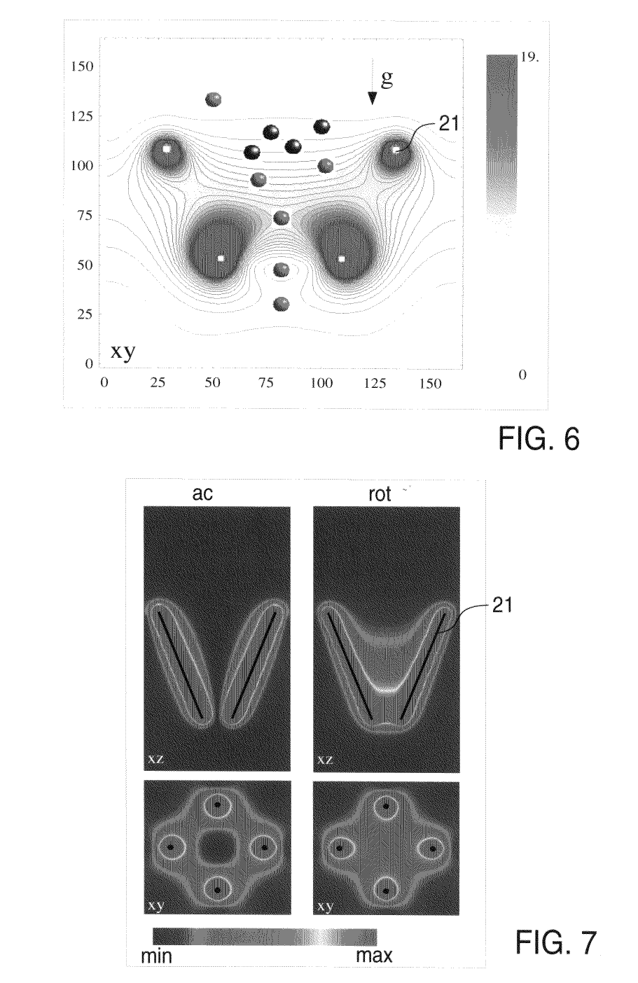

FIGS. 6 and 7: show illustrations of the separating fields generated in a manipulation device according to the invention,

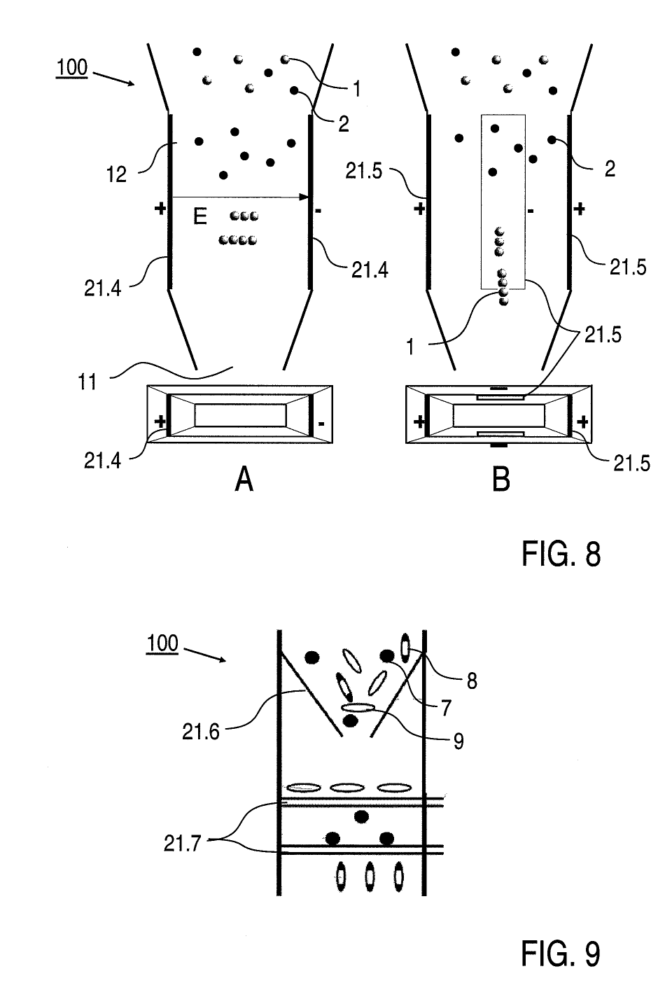

FIGS. 8 and 9: show illustrations of sedimentation and orientation steps in a manipulation device according to the invention, and

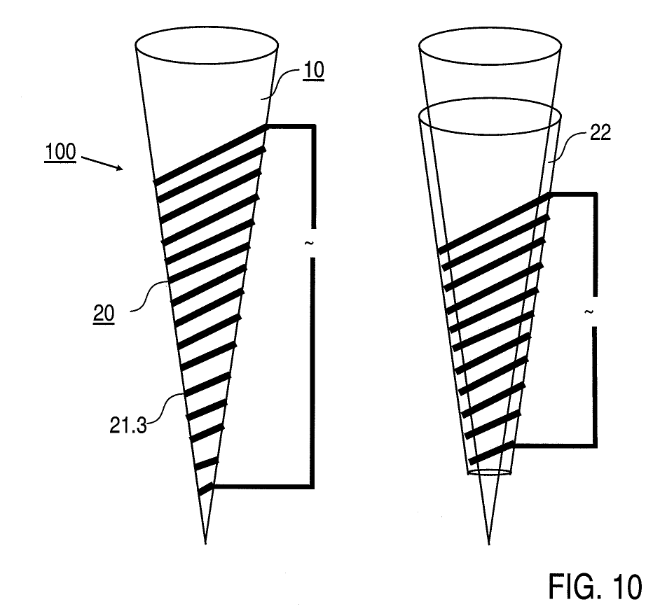

FIG. 10: shows embodiments of the manipulation device according to the invention, in which a pipette tip is equipped with a magnetic field device.

The invention will be described by way of example below with reference to the use of pipette tips for the electric or magnetic manipulation of suspended particles. It is emphasized that the invention can be implemented in the same way if the separating device is provided on the reservoir of a liquid pipette or another liquid reservoir (e.g. suction pipette, siphoning pipette, capillary tube, fluidic hollow line).

FIG. 1A shows, in a schematic sectional view on an enlarged scale, the manipulation device 100 in which a pipette tip 10 is provided as the liquid siphoning device. The siphon opening and the siphon channel are accordingly formed by the pipette opening 11 and the pipette channel 12. At a distance from the free end of the pipette tip 10, an electrode device 20 with strip-shaped electrodes 21.1, 21.2 is arranged as the separating device. The pipette tip 10 has the same dimensions as conventional, commercially available pipette tips from manufacturers such as e.g. Gilson or Eppendorf. The interior volume of the pipette channel 12 is for example 5 μl to 200 μl.

The pipette tip 10 may be made of known materials such as glass, plastics, ceramic or silicon, which can easily be provided with electrodes. It is also possible to use composite materials such as plastics provided with conductive nanoparticles, which can be formed inexpensively by means of injection molding methods and can be optically provided with conductor tracks for example. It may in particular be advantageous to integrate a plurality of sub-channels into the pipette channel. This can be inexpensively achieved for example using the technology known from WO 2004/076060. The manipulation region of the pipette may be shaped differently (e.g. circular or rectangular cross section) and may be formed with constant dimensions or in a conical manner.

In addition, a material which differs dielectrically (conductivity/dielectric constant) from the medium may be incorporated in the pipette tip 10, e.g. as a porous bung which generates field inhomogeneities for particle separation (see Lapizco-Encinas et al. “Dielectrophoretic concentration and separation of live and dead bacteria in an array of insulators” in “Analytical Chemistry” vol. 76, 2004, pages 1571-1579).

The electrodes 21.1, 21.2 comprise at least two electrically conductive conductor tracks which are connected to a power supply device (not shown) in order to generate electric separating fields. In a manner electrically insulated from one another, the electrodes 21.1, 21.2 are arranged preferably on the inner side of the pipette tip 10 or alternatively in the wall thereof or on the outer surface thereof. For the sake of better clarity, the figures show the electrodes on the outer side of the pipette tip. The electric fields (separating fields) generated by the electrodes act in a certain spatial area depending on their magnitude; this area is referred to here as the manipulation region. In the manipulation region, the pipette tip 10 has a cross-sectional dimension preferably in the range from 100 μm to 1 mm.

As an alternative to the illustrated conical shape of the pipette tip 10, other cross-sectional shapes of the pipette channel 12 may be provided. The pipette channel 12 may for example widen in a stepped manner starting from the pipette opening 11 with a narrow section to a section with a larger internal dimension, wherein the electrode device 20 is in this case provided at the upper end of the narrow section before the stepped widening.

FIG. 1A also shows, in a sample reservoir 70, a suspension sample containing different particles 1, 2 in a carrier liquid 3. The sample reservoir 70 is for example a compartment of a microtiter plate. The different types of particles 1, 2 comprise e.g. different cell populations which differ in terms of their passive dielectric properties and/or their shape, geometry or size. The separation of the cell populations by the method according to the invention is illustrated in FIGS. 1B to 1F and comprises the following steps.

As shown in FIG. 1B, firstly the carrier liquid containing the particles is taken up into the pipette tip 10. To this end, the pipette tip 10 is attached to a laboratory pipette (not shown) and subjected to a negative pressure by means of a pressure piston. The carrier liquid is taken up firstly into the lower section of the pipette tip 10 below the electrode device 20 (FIG. 1B). The dotted line 3.1 represents the meniscus of the carrier liquid 3.

Then, as shown in FIG. 1C, further buffer liquid 4 is taken up from a buffer reservoir 71 so that the carrier liquid containing the particles is displaced into the manipulation region between the electrodes 21.1, 21.2. The interface between the carrier liquid 3 and the buffer liquid 4 is marked by a dotted line (3.2).

The buffer liquid 4 may have different physical properties from the sample. In particular, the density or viscosity may be varied or it may differ in terms of the conductivity or dielectric constant. With an increased density, the particles in the buffer liquid can firstly be compressed. The narrower band can then be accelerated by applying additional forces (centrifugation, magnetic field). Changed dielectric properties of the buffer liquid may be used to set more favorable conditions for the dielectrophoresis.

After loading the pipette tip 10 with the carrier and buffer liquids 3, 4, the pipette tip 10 (preferably together with the laboratory pipette) is positioned in a holding device 30 as shown schematically in FIG. 1D. The holding device 30 comprises a frame with an electrical connection 31 for connecting the electrodes 21.1, 21.2 to a power supply device.

The separation of the particles 1, 2 into different particle fractions takes place in three stages, which are illustrated in FIGS. 1D to 1F. In a first step, the pipette tip is held vertically in the holding device 30 for a predefined separation time T_{z}. During this, the lower pipette tip can rest in a vessel or on a substrate (not shown). At the same time, high-frequency electric fields are generated by the electrodes 21.1, 21.2 in the manipulation region. Depending on the specific separating task, the fields typically have frequencies in the range from 1 kHz to 100 MHz and voltages in the range from 1 V to 20 V. The fields are generated by AC voltages or cyclic voltages.

The high-frequency electric separating fields are generated in such a way that the type consisting of the first cell population (white circles) forms a first particle fraction 5 and can sink downwards into the pipette tip 10 following the sedimentation movement, while the type consisting of the other cell population (black circles) forms a second particle fraction 6 and is held back in the manipulation region by positive dielectrophoresis. The specific field properties (frequencies, phases, amplitudes) to be set in order to achieve separation of the particles depends on the particles used in the specific case. Control protocols for applying voltages to electrodes for the negative or positive dielectrophoretic manipulation of particles can be selected by the person skilled in the art in the manner known from the fluidic microsystem technique or can be determined by preliminary experiments.

The separation time is determined from the difference in mass densities between the cells (e.g. 1.05 g/cm³) and the carrier liquid (e.g. 0.9 g/cm³). For cell sizes in the range from 5 μm to 30 μm, a separation time of up to approx. 60 min is obtained.

In a further separating step (FIG. 1E), a predefined volume of the sedimented particle fraction 5 is discharged from the pipette tip 10 into a target reservoir 72 (e.g. compartment of a microtiter plate). In this phase, the particle fraction 6 can still be held in the manipulation region or, as illustrated, can be flushed out therefrom. However, the volume of the particle fraction 5 to be discharged into the target reservoir is selected such that the particle fraction 6 does not also pass into the target reservoir 72. In a final step, the particle fraction 6 is transferred into a further target reservoir 73 or a waste container (FIG. 1F).

It may be provided according to the invention that the particle separation is accelerated in a centrifuge. After separation has taken place, the particles/cells in one or more fractions can be flushed out of the pipette.

As an alternative to the variant shown in FIG. 1, the pipette tip may also be placed directly in a vessel, with one particle fraction sedimenting directly into this vessel. If, during the separation of two types of particles, one type is fully held back in the manipulation region and the manipulation region starts directly at the pipette tip, then the step of taking up the separation medium may optionally be omitted. As a result, systems with integrated cell work-up (cell fractionation, cell purification, etc.) are obtained which are easy to handle with regard to fluidics and are compatible with laboratory diagnostics, which systems can moreover easily be automated (pipetting machines).

In order to make it easier to set the volumes for the take-up and discharging of the carrier and buffer liquids 3, 4, the pipette tip 10 or the laboratory pipette may be provided with a measurement scale. Alternatively, the electrode strips extending perpendicular to the length of the pipette channel 12 may be used as a measurement scale.

For typical cell sizes of approx. 15 μm and given differences in density of approx. 60 kg/m³, the force acting in the Earth's field in the pipette tip 10 is approx. 1 pN. In aqueous solutions, therefore, this results in an uninfluenced sinking rate of approx. 7.4 μm/s. Approx. 135s are thus required per 1 mm of separation distance. Dielectrophoretic forces can easily be set in the range from nN up to several tens of pN via suitable voltages or frequency settings. If a sample of height h in the pipette is to be completely separated, and if the dielectrophoretic forces are set for example such that particle type 1 is unaffected and particle type 2 sediments at half the sinking rate, then a separation distance of at least h must be traveled. In the case of a sample height of 1 cm, this corresponds to a time of approx. 45 minutes. The necessary separation times and distances are proportional to the speed ratio. The (theoretical) minimum separation distance and time results for the case where one particle type is completely held back (0 cm and 22.5 min in the above example). It is therefore advantageous to use settings with high sinking speed ratios.

Since in narrow channels the dielectrophoretic forces necessary for this can be achieved with low voltages, it is advantageous to use a plurality/a large number of sub-channels per pipette channel (DEP-well technology). The sub-channels have characteristic dimensions of e.g. 300 μm.

During the separation phase, the particles may be exposed to further forces, e.g. magnetic fields (e.g. in order to accelerate the sedimentation) or ultrasound (in order to avoid clumping of particles). Magnetic forces may be applied from outside (see FIG. 2D) or else internally by means of microelectrodes, as disclosed for example in DE 103 55 460 A1. In the latter case and when using magnetic or magnetizable particles (e.g. so-called Dynabeads), it is optionally possible to omit electrical separation entirely.

FIG. 2 shows a modified embodiment of the method according to the invention for manipulating suspended particles 1, 2 (e.g. biological cells) in a carrier liquid 3. In this embodiment, the liquid siphoning device consists of a pipette tip 10 and an electrode device 20 with electrodes 21.1, 21.2 (FIG. 2A), as described above (see FIG. 1A). However, unlike in the method described above, it is provided in FIG. 2 that the two-stage take-up of the suspension sample (carrier liquid containing particles) results in a greater displacement of the suspension sample. In a first step, the particles are taken up with the carrier liquid into the lower section of the pipette tip 10. In a second step, so much buffer liquid is taken up from a buffer reservoir 71 that the particles are transported into an area above the manipulation region (FIG. 2C).

In order to separate the particles into different particle fractions, the pipette tip 10 (with the laboratory pipette) is inserted into the holding device 30 (FIG. 2D). The particles sediment through the manipulation region between the electrodes 20, with separating forces of different strength being exerted on the different particles by means of negative dielectrophoresis in the direction opposite the sedimentation direction. As a result, firstly the particle fraction 5 passes into the target reservoir 72. While the particle fraction 5 passes through the manipulation region, the electrodes 21.1, 21.2 can be switched to a mode in which positive dielectrophoresis is produced and the particle fraction 6 is held back in the manipulation region. The separation sharpness of the method according to the invention is increased as a result.

FIG. 2D schematically shows further details concerning the holding device 30 with the electrical connection 31, the power supply device (generator) 32, switching and contacting electronics 33 and a magnet control system 34. By means of the magnet control system 34, a magnet 35 which can be switched on and off electrically below the pipette opening 11 of the pipette tip 10 can be switched on in order to generate an additional magnetic sedimentation force and to increase the sinking speed of magnetic particles.

The holding device 30 may be equipped with further modules, e.g. with a drive module for the pressure piston of the laboratory pipette. By means of the drive module, a weak volume flow through the pipette channel 12 can be produced according to the function of an injection pump, as a result of which the separation of the particles is advantageously accelerated. The holding device 30 may also be part of a centrifuge.

FIG. 3 shows three variants of the configuration of an electrode device 20 which may be arranged on the inner wall of a pipette tip 10. In FIG. 3A, the electrode device 20 comprises two electrodes 21.1, 21.2 which engage in one another in a comb-like manner and have radially running electrode strips which are controlled by two signals with a phase shift between them of 180° (+/− represent the 180° phase shift). In FIG. 3B, a more complex electrode geometry is provided, in which four comb-like electrodes are arranged in such a way as to engage in one another, wherein two respective electrode pairs have a relative phase shift of 90°. The configurations shown in FIGS. 3A and 3B are preferably used in a pipette tip with a cylindrical pipette channel 12 (plan view in the lower parts of FIGS. 3A, 3B).

FIG. 3C shows a modification in which the electrodes are arranged as axially running strips on the inner wall of a conically tapering pipette channel 12. By way of example, four electrodes arranged opposite one another are provided (plan view in the lower part of FIG. 3C), said electrodes being acted upon by signals with a relative phase shift of 90° in each case. According to a corresponding modification (not shown), it is also possible for three electrodes to be arranged offset from one another by 120° in each case, and to be acted upon by signals with a mutual phase shift of 120°.

FIG. 4 shows an embodiment of the manipulation device 100 according to the invention, in which a multipipette 10 with a plurality of pipette tips 10.1, 10.2, 10.3 and 10.4 is provided as the liquid siphoning device. The schematically shown pipette 10 is designed in the same way as conventional multipipettes. The separating device 20 comprises a plurality of electrode devices 20.1, 20.2, 20.3 and 20.4 which are respectively arranged on the pipette tips 10.1, 10.2, 10.3 and 10.4.

The manipulation of a suspension sample using the manipulation device 100 shown in FIG. 4 takes place in the same way as described above. Advantageously, however, a plurality of sample suspensions can be separated simultaneously with this embodiment. Furthermore, this variant comprising a plurality of pipette tips per pipette is particularly suitable for automating the particle manipulation.

FIG. 5 shows a further example of embodiment of the manipulation device 100 according to the invention, in which the liquid siphoning device comprises a two-channel pipette 10. In this example of embodiment, the separating device 20 is provided in the pipette reservoir above the pipette tips.

As shown in FIG. 5A, the two-channel pipette 10 has two tubular pipette channels 12.1, 12.2 for taking up the sample and one pipette reservoir 13. In this embodiment of the invention, the electrode device 20 is arranged in the pipette reservoir 13. The electrode device 20 with at least two electrical conductors 21.1, which allow an application of alternating electric fields, is fitted in an electrically insulated manner in the upper region of the pipette 10 exclusively above one of the pipette channels (12.2). The pipette 10 has an asymmetric pipette reservoir 13. The volume of the pipette reservoir 13 above the electrodes 21.1 and the pipette channel 12.2 is greater than the corresponding volume above the pipette channel 12.1.

The carrier liquid 3 in the sample reservoir 70 contains two different cell populations 1, 2, which differ in terms of their passive dielectric properties, shape, geometry and/or size.

For the separation of the particles according to the invention, in FIGS. 5A, B both pipette channels are filled with the mixed population of the particles 1, 2 in a first step. In a second step, buffer liquid is additionally taken up from a buffer reservoir 71 (FIG. 5B). As a result of the buffer liquid being taken up, the mixed population of the particles 1, 2 passes into the common space above the electrodes 21.1 (FIG. 5C).

The cell separation then takes place as shown in FIG. 5D. The particle fractions 5, 6 are formed in the pipette channels not in a temporally separate manner as in the method described above, but rather in a spatially separate manner. For the sedimentation, the pipette 10 can be placed in a holding device (not shown, similar to that shown in FIG. 2).

In order to bring about the separation, the electrode device 20 is activated. The cells 1, 2 pass into the region of the electrode device 20 preferably as a result of sedimentation or via a manual or mechanical force. Due to the dielectric differences, the first particle type can pass through the electrode device 20 unhindered and can reach the pipette channel 12.2, while the second particle type is deflected by the electrode device 20 and transferred into the pipette channel 12.1. Thereafter, the different fractions 5, 6 can be collected in separate vessels.

One particular advantage of the sorting process described here is that the particles, after separation in the region of the electrode device, do not need to sediment to the lower end of the pipette channels for removal purposes but rather can be flushed out separately after entering the pipette channel.

FIG. 6 shows the dielectrophoretic potential (mean E²) for an electrode structure comprising 2-ring electrodes 21 and a conical channel (as in FIG. 1) in the central section parallel to the length of the pipette tip. In addition, two different particle types are shown, with the dark particles being held back by negative dielectrophoresis to a greater extent that the light particles and therefore not sedimenting as quickly as the latter. FIG. 7 shows the dielectrophoretic potential (mean E²) for the electrodes 21 (marked in black) shown in FIG. 3C when actuated with an alternating field (“ac”, 2-phase, left) and with a rotating field (“rot”, 4-phase, right).

FIGS. 6 and 7 show that the particles can also be influenced in the vicinity of a single electrode. However, a two-electrode arrangement makes it possible to set precisely defined conditions. In the simplest case, said electrode arrangement consists of two rings (FIG. 6). The particles are dielectrophoretically centered in the field and sediment towards the tip 11 (see FIG. 1A) of the pipette 10. In FIG. 7, in the “ac” mode, the electric field disappears in the axis of symmetry and the particles are subjected to a force proportional to the 5th power of the particle radius. Under negative dielectrophoresis conditions, therefore, smaller particles sediment more quickly than larger particles. In the rotating field mode “rot”, the dielectrophoresis dipole forces dominate, which are proportional to the particle volume.

For uniform separation, it may be advantageous to allow constant dielectrophoretic forces to act in the sedimentation direction (fields with constant gradients, so-called “isomotive electric fields”, see e.g. Li et al. “Dielectrophoretic fluidic cell fractionation system” in “Analytica Chimica Acta” vol. 507, 2004, pages 151-161). The change in sedimentation speed can be achieved not just via dielectrophoresis or traveling wave dielectrophoresis, but also via induced particle aggregation (see T. B. Jones “Electromechanics of Particles”, Cambridge University Press, New York City, N.Y., 1995, ISBN 0-521-43196-4, Chapter 7.6, pages 212-216) and, in the case of non-spherical objects (e.g. bacteria, red blood cells, thrombocytes, CNTs (carbon nanotubes) etc.), via reorientation (see T. B. Jones “Electromechanics of Particles” Chapter 5.4., pages 124-126) in the electric field. If these effects are used not in parallel but rather as alternatives, this has the advantage that only particularly simple electrode arrangements are required in order to generate homogeneous electric fields. Instead of the 4-electrode arrangement shown in FIG. 3C, it is possible for example simply to use two electrodes arranged opposite one another and controlled with opposite phases, wherein the pipette may be of non-conical design. The opposite-phase control can also be replaced by single-phase control, with the second electrode being at (virtual) ground.

This also applies analogously in the case of magnetic fields, in which induced aggregation or orientation can again be used.

Since both the sedimentation and the dielectrophoresis represent volume forces in dipole approximation, cells can be fractionated in a particularly effective manner according to their size if the cells are manipulated by a suitable electrode geometry and electrode control in regions with a disappearing dipole force component and e.g. separation takes place according to quadrupole force components.

Reorientation is also a general separation possibility, since the flow resistance depends on the orientation of the particles. While pure particle aggregation to form spherical objects can be used for this only in special field distributions with e.g. a disappearing dipole moment in the axis of symmetry (FIG. 7, ac), field-induced particle aggregation to form non-spherical objects (e.g. pearl chains in homogeneous fields) is excellent since the flow resistance depends on the orientation. If e.g. non-spherical particles are to be separated from one another or from spherical particles, then by suitably selecting the frequency and optionally the buffer liquid at least one particle type on average is oriented with the larger “half-axis” parallel or anti-parallel to the electric (magnetic, optical) field. In addition, the second particle type may be oriented perpendicular to the first. One important technical use consists in the separation of conductive and semiconductive CNTs, which arise on a random basis during production.

According to the invention, therefore, in addition to the phenomenon of different sinking speeds of oriented non-spherical objects, such as non-spherical biological cells, e.g. red blood cells, or synthetic objects, e.g. carbon nanotubes, the aggregation of the objects in electric and/or magnetic fields and the associated changed sedimentation speed can also be used for particle manipulation and in particular separation. This embodiment of the invention is based in particular on the finding that, during the accumulation of particles, the flow resistance generally increases to a lesser extent than the sedimentation force. For two spherical objects having the same radius and touching one another, then e.g. for double the mass (sedimentation force) only an approx. 1.3 to 1.5-fold increase in the hydrodynamic friction force occurs, depending on the orientation, compared to the individual spherical object and thus a corresponding increase in the sedimentation speed (see e.g. C. Binder et al. in “Journal of Colloid and Interface Science” vol. 301, 2006, pages 155-167). The sedimentation of aggregates will be explained below with reference to FIG. 8.

According to a first variant, the field-induced particle aggregation can be achieved in homogeneous fields. In this variant, it is known for example as pearl chain formation (see T. B. Jones “Electromechanics of Particles”, Chapter 6 “Theory of pearl chains”, pages 139 ff.). FIG. 8A shows the formation of particle aggregates (in particular particle chains or particle carpets) in the homogeneous or almost homogeneous electric field. The manipulation device 100 (side view at the top, plan view at the bottom) has electrodes 21.4 on opposite walls of the siphon channel 12 formed with a rectangular cross section, which electrodes are alternately subjected to a positive or negative voltage in order to form a homogeneous electric field. The symbols +/− show the phase of the electric field or the charge on the electrodes at a fixed point in time. Due to the reduced flow resistance per particle of the aggregated objects, particle separation occurs. Here, the field frequency of the electric field is selected in such a way that particle type 1 is subject to a greater aggregation force in the electric field than particle type 2.

According to a second variant, aggregates can also be generated in inhomogeneous fields by dielectrophoresis or magnetophoresis and can be used for the separation. FIG. 8B shows that, in a quadrupole field generated by four electrodes 21.5, the particles 1 with stronger negative dielectrophoresis are arranged one above the other in the central axis (E==0) and in this formation sediment more quickly than the weaker, i.e. barely dielectrophoretically centered particles 2. Coils are used in a corresponding manner for magnetophoresis (see e.g. DE 10355460.2).

The filling of the manipulation device 100 according to FIG. 8A or 8B with a particle suspension may take place via the siphon opening 11 provided at the lower end or via the opposite, upper end of the siphon channel 12. A particularly sharp separation into fractions can be achieved if the particles are initially located above the electrodes and the field frequency and voltage or phase pattern are set such that the particles initially cannot pass into the separating region comprising the electrodes. As a result, defined starting conditions are advantageously set. Optionally, an undesirable random or field-induced particle aggregation can be minimized or suppressed in this phase by coupled-in vibrations (e.g. ultrasound). The actual separating process than starts by changing the phase pattern, voltage and/or frequency of the electric field.

As a modification to FIG. 8, two electrode regions may be provided, wherein the particles are firstly filled into an upper electrode region and exposed to a first aggregation field, which simultaneously holds back the objects, and sediment into a lower electrode region. If the particles tend towards active aggregation after making contact (e.g. biological cells), the lower electrode region can be omitted.

The orientation of aggregates will be explained below with reference to FIG. 9, which illustrates by way of example two force-induced orientation effects which may lead to a different sample separation. For the first effect, at least one orientation electrode 21.6 is arranged in the siphon channel 12. The orientation electrode 21.6 is e.g. a dielectrophoretic funnel, as known from the fluidic microsystem technique. The orientation electrode 21.6 is arranged in the siphon channel 12 such that it extends axially. For the second effect, at least one retaining electrode 21.7 is provided in addition or as an alternative. The retaining electrode 21.7 comprises e.g. parallel annular sub-electrodes in the form of strips or so-called zigzag elements, as known from dielectrophoretic manipulation. The retaining electrode 21.7 is arranged in the siphon channel 12 so as to run radially around the latter. According to the invention, a separating cascade can be formed which comprises a combination of at least one orientation electrode 21.6 and at least one retaining electrode 21.7, e.g. at least two retaining electrodes 21.7 and/or at least two orientation electrodes 21.6, which are operated e.g. at two different frequencies.

A suspension which is to be separated in the manipulation device 100 (partially shown) contains e.g. spherical particles 7 and two types of ellipsoid particles 8, 9. When the suspension reaches the orientation electrode 21.6 which is acted upon by an alternating voltage, the particles are rotated (reoriented) in the active range of the orientation electrode 21.6 as a function of the frequency of the alternating voltage. By way of example, for ellipsoids, predefined preference frequencies are set for which an orientation occurs transversely to or along the field vector of the orientation electrode 21.6. This rotation (orientation) then has an effect on the sedimentation behavior of the particles. For the mixture of different particle types, electric fields with different frequencies adapted to the respective types of particles are applied to the orientation electrode 21.6. The different frequencies can be simultaneously superposed or generated in an alternating manner.

When the suspension reaches the retaining electrode 21.7 which is acted upon by an alternating voltage, and if the frequency of the alternating voltage at a sub-electrode is selected in such a way that all the ellipsoid particles or a certain sub-group thereof are arranged transversely to the flow, then the corresponding retaining force is increased and the particles are delayed much longer than spheres or other ellipsoids which are oriented in the flow direction.

The suspension to be separated contains e.g. biological materials, such as cells, or artificial components, such as carbon fibers, which may in each case consist of spherical and elongate-ellipsoid-like objects. With particular advantage, the invention can be used with suspensions which contain blood cells. It is known from rheology that blood cells are arranged differently in different strengths of flow (so-called “sludge” phenomenon). This changes their flow behavior. Moreover, the rheological behavior of blood cells can be used to diagnose certain diseases or pathological changes. In addition, the speed of separation of serum and plasma components during conventional blood sedimentation can be used to assess pathological changes in the blood.

FIG. 10 shows embodiments of a manipulation device 100 according to the invention comprising a magnetic separation in a pipette tip 10. As shown in FIG. 10A, a conical pipette tip 10 is equipped with a magnetic field device 20 which comprises a coil winding 21.3 on the outer surface of the pipette tip 10. When an electric current is applied to the coil winding 21.3, an inhomogeneous magnetic field is generated in the pipette tip 10. As an alternative, the pipette tip 10 according to FIG. 10B is inserted in a corresponding coil insert 22, which has the particular advantage that no electrode has to be integrated in the pipette tip 10. Conventional pipette materials such as glass, ceramic or plastic are advantageously penetrated well by the magnetic field. The separation of particles takes place in the same way as in the method described above.

In a manner analogous to FIG. 10B, for electrical separation too it is possible to omit internal electrodes in the liquid siphoning device. This is preferred for relatively simple electrode arrangements (e.g. in FIG. 3). For aqueous solutions, in the case of external electrodes it is preferable to use electrically strongly polarizable pipette materials (composites) so as to be able to couple enough field strength into the sample at sufficiently high field frequencies (low-frequency electric fields are generally well-shielded from the charge carriers in aqueous solutions). For synthetic particles (such as CNTs for example) or bacteria (e.g. in drinking water), which can be suspended in media with a low conductivity and a low dielectric constant, the necessary (homogeneous) electric field can be generated entirely externally in a particularly simple manner.

The embodiments can also be modified in such a way that the magnetic separation is restricted just to an upper region of the pipette tip 10. Non-magnetized particles are thus separated out first. An embodiment which can be switched on and off and which is adjustable with regard to the magnetic field strength then allows even a continuous separation of the objects. The electric separation as described above may additionally be provided.

The features of the invention which are disclosed in the above description, the claims and the drawings may be important both individually and in combination with one another for implementing the invention in its various embodiments.

1. A method for manipulating particles suspended in a carrier liquid, comprising the steps:
take-up of the carrier liquid containing the particles into a liquid siphoning device,
generation of electric and/or magnetic separating fields in the liquid siphoning device,
sedimentation movement of the particles in the liquid, wherein each particle has sedimentation speed which depends on an effect of the separating fields on the particle, and the particles form a plurality of particle fractions as a function of their sedimentation speeds, and
discharging of the particle fractions from the liquid siphoning device.

2. The method according to claim 1, in which the carrier liquid containing the particles is taken up into the liquid siphoning device through at least one siphon opening under an effect of a negative pressure.

3. The method according to claim 1, in which, after the carrier liquid has been taken up, a buffer liquid is taken up into the liquid siphoning device.

4. The method according to claim 1, in which the particle fractions are discharged from the liquid siphoning device one after another in a temporally separate manner.

5. The method according to claim 1, in which the particle fractions are discharged from the liquid siphoning device in a spatially separate manner.

6. The method according to claim 4, in which the particle fractions are discharged from the liquid siphoning device through the at least one siphon opening.

7. The method according to claim 1, in which the electric separating fields produce negative dielectrophoretic separating forces of different strength for different particles.

8. The method according to claim 1, in which the electric separating fields produce positive dielectrophoretic separating forces for a portion of the particles.

9. The method according to claim 1, in which the electric separating fields produce no separating forces for a portion of the particles.

10. The method according to claim 1, in which the magnetic separating fields form a magnetic field gradient in the liquid siphoning device.

11. The method according to claim 1, in which the particles are exposed to different separating fields simultaneously or in temporal succession during the sedimentation movement.

12. The method according to claim 1, in which the separating fields are generated in such a way that an aggregation and/or an orientation of the particles takes place as a function of a predefined particle property.

13. The method according to claim 12, in which the aggregation and/or the orientation of the particles takes place as a function of a particle shape, particle geometry, a particle structure and/or a particle composition.

14. The method according to claim 1, in which the sedimentation movement takes place under an effect of at least one sedimentation forces selected from the group consisting of a gravitational force, a magnetic sedimentation force, a dielectrophoretic sedimentation force, an electrophoretic sedimentation force, an electromagnetic sedimentation force and a centrifugal force.

15. The method according to claim 1, in which the carrier liquid in the liquid siphoning device is subjected to ultrasound.

16. The method according to claim 1, in which, after the carrier liquid has been taken up, the liquid siphoning device is positioned in a holding device.

17. The method according to claim 16, in which the positioning of the liquid siphoning device includes establishing an electrical connection between a separating devices for generating the separating fields and a power supply device.

18. The method according to claim 1, in which the particles comprise biological cells, biological cell aggregates, biological cell components, biological macromolecules, viruses, synthetic materials or a combination thereof.

19. The method according to claim 1, in which an electric field treatment of the particles is provided.

20. The method according to claim 19, in which the particles comprise biological cells and the electric field treatment comprises a cell poration or a cell fusion.

21. The method according to claim 1, in which the take-up of the carrier liquid containing the particles, into the liquid siphoning device comprises a simultaneous suction of the carrier liquid into a plurality of siphon channels of the liquid siphoning device.

22. The method according to claim 1, in which a pipetting device or a part thereof is used as the liquid siphoning device.

23. A manipulation device for manipulating particles which are suspended in a carrier liquid, comprising:
a liquid siphoning device for taking up the carrier liquid, and
a separating device for generating electric and/or magnetic separating fields in the liquid siphoning device.

24. The manipulation device according to claim 23, in which the separating device is arranged in at least one siphon channel of the liquid siphoning device.

25. The manipulation device according to claim 23, in which the separating device is arranged on an outer side of the liquid siphoning device.

26. The manipulation device according to claim 25, in which the separating device is releasably fixed to the outer side of the liquid siphoning device.

27. The manipulation device according to claim 23, in which the separating device for generating the electric separating fields comprises an electrode device.

28. The manipulation device according to claim 23, in which the separating device for generating the magnetic separating fields comprises a magnetic field device.

29. The manipulation device according to claim 23, in which the liquid siphoning device comprises one or more siphon channels, through which the carrier liquid can be taken up into the liquid siphoning device.

30. The manipulation device according to claim 29, in which at least one of the siphon channels contains a plurality of sub-channels.

31. The manipulation device according to claim 23, in which the liquid siphoning device comprises a material which differs dielectrically from the carrier liquid.

32. The manipulation device according to claim 23, in which the liquid siphoning device comprises at least one material selected from the group consisting of glass, plastic, ceramic, silicon and plastic nanoparticle composite.

33. The manipulation device according to claim 23, in which the liquid siphoning device comprises a pipetting device or a part thereof.

34. The manipulation device according to claim 33, in which the liquid siphoning device comprises a pipette tip, to which the separating device is connected.

35. The manipulation device according to claim 33, in which the liquid siphoning device comprises a pipette reservoir, to which the separating device is connected.

36. The manipulation device according to claim 23, which is equipped with a holding device for positioning the liquid siphoning device.

37. The manipulation device according to claim 36, in which the holding device is designed to electrically connect the separating device to a power supply device.

38. A method of manipulating compositions comprising biological particles, said method comprising:
providing a manipulation device according to claim 23; and
manipulating the composition to sort the biological particles or to purify the composition, wherein the composition being purified is a biological particle suspension.

39. A method of manipulating suspended particles, said method comprising:
providing a pipette tip equipped with a separating device for generating electric and/or magnetic separating fields, and
manipulating the suspended particles with the pipette tip.
